(19) United States
(12) Patent Application Publication
(10) Pub. No.: US 2022/0284128 A1
(43) Pub. Date: Sep. 8, 2022

(54) SMARTPHONE APPLICATION DATA SECURITY MODULE

(71) Applicant: Ramesh Arumugam, HOUSTON, TX (US)

(72) Inventor: Ramesh Arumugam, HOUSTON, TX (US)

(21) Appl. No.: 17/192,218

(22) Filed: Mar. 4, 2021

(51) Int. Cl. G06F 21/62; G06F 21/60; G06F 21/54

(52) U.S. Cl. CPC G06F 21/6281; G06F 21/604; G06F 21/54

(57) ABSTRACT

smartphone applications need certain level of permission to access and play with the internal device and its drivers. Permission to access the devices and drivers play a major role, sometime the application itself will display the permissions which is necessary for the optimum performance for the expected results. We develop an application which display the permission chart for all the applications installed in the systems, it displays the entire devices permission in a one shot place.

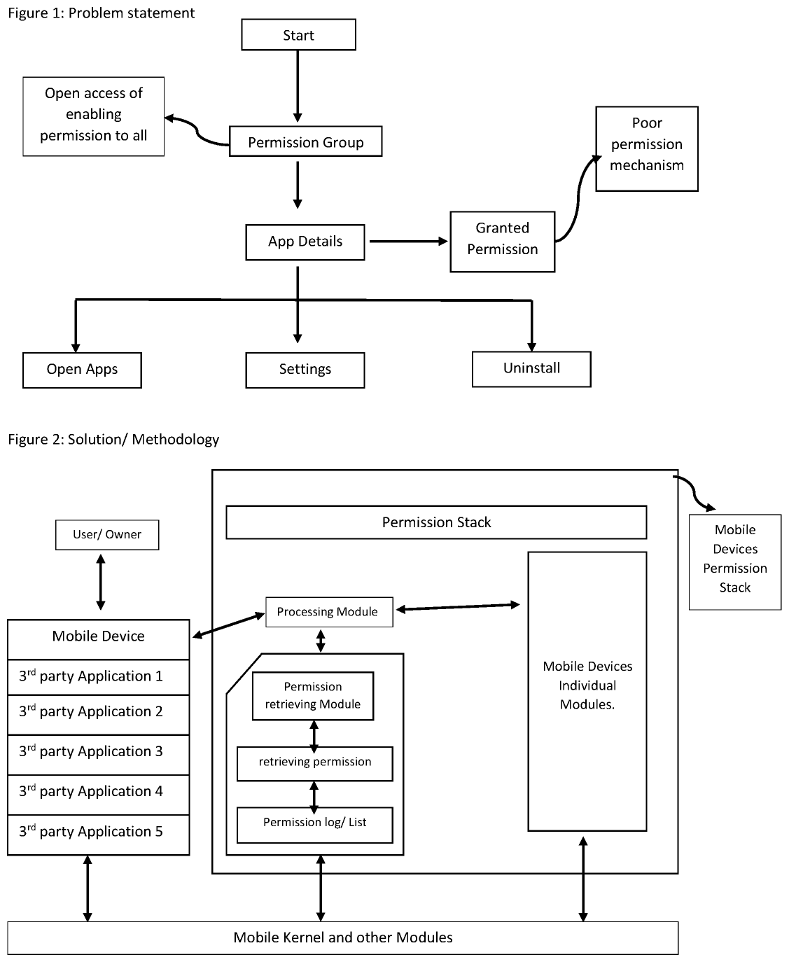

### CROSS REFERENCE OF RELATED APPLICATIONS

Not Applicable

### FIELD OF THE INVENTION

The present invention relates to Smartphone security application developed to run on all platforms including but not limited to Ios, Android and Windows to alert users when their data is stolen without their permission.

### BACKGROUND OF THE INVENTION

Weakened security in the smartphone world has become a huge opportunity for the hackers. Targeting potential users, such as executives, high-level business magnets and of course the beginner users has become a game in the day to day speedy life. New apps emerge in the market day by day and the list of vulnerabilities grow day by day. All problems start while we grant permission during the time of application installation. Our security researchers and security developers have come with the crystal clear security solutions for the problem, we design an application to display the list of inherited permissions and granted permissions, sometime influential permission which was always misused in the browser application. A user friendly one button to turn off all data leaks and also custom buttons to control data that is shared with specific applications according to the needs of the customers.

### SUMMARY

Illustrative embodiments of the disclosure are generally directed to a. The xx serves to

### BRIEF DESCRIPTION OF THE DRAWINGS

Problem area has been given in a figurative manner

### DETAILED DESCRIPTION OF THE INVENTION

Given the diagram, which have highlighted the problem areas and vulnerable checkpoint. The problem areas are tagged and known for the soft spot tweaked while programming to request permission granting or to evade permissions.

Our developed android security handlers collect the granted permissions from the logs and display it in a diligent manner.

System level permissions are granted when the application is installed, the granted permissions are displayed as system functions

Grant access list/permission obtained during the time of installation will be displayed in the “Grant Permission column”

Shared the reference screenshot of permission group and grant permission details from an Application

Permissions screenshot shared for our reference

1. Application installation will not ask any deliberate permissions except the permissions to access application logs.

2. Permission Group will be displayed as a basic feature.

3. Grant permission will be displayed inside the Applications details.

4. Application details Grant permission section will display the ACCESS method of the systems function.

5. App audit feature is added as an additional security pitch to monitor the motion of the permission calls.
